(19) United States
(12) Patent Application Publication
(10) Pub. No.: US 2021/0270417 A1
(43) Pub. Date: Sep. 2, 2021

(54) Mounting Assembly for Attaching Objects to Trees

(71) Applicants: Peter van Kleef, Hilton Head Island, SC (US); Jack Aldrich, Port Royal, SC (US)

(72) Inventors: Peter van Kleef, Hilton Head Island, SC (US); Jack Aldrich, Port Royal, SC (US)

(21) Appl. No.: 17/188,474

(22) Filed: Mar. 1, 2021

Related U.S. Application Data
(60) Provisional application No. 62/983,389, filed on Feb. 28, 2020.

(51) Int. Cl. F16M 13/02

(52) U.S. Cl. CPC F16M 13/022; F21V 21/00

(57) ABSTRACT

A mounting assembly for demountable attachment to a tree. The assembly includes a mounting base, primary fasteners, and secondary fasteners. The mounting base includes a main body, first arm, and second arm. The mounting base is planar and rectangular. The main body includes a mounting hole medially located on the main body. The first and second arms extend from the main body opposite the mounting hole and thereby form a mounting slot. The first and second arms are positioned proximate and parallel to each other. The mounting slot is longitudinally positioned along the mounting base. The primary fasteners include first and second fasteners. First fasteners are demountably positioned in the mounting hole. Second fasteners are slidably and demountably positioned in the mounting slot. The mounting base is adapted to be attached to the tree via the primary fasteners. Secondary fasteners are adapted to affix fixtures to the main body.

### CROSS-REFERENCE TO RELATED APPLICATIONS

This application claims priority to U.S. Provisional Application No. 62/983,389 filed Feb. 28, 2020, which is hereby incorporated herein by reference.

### FIELD OF THE INVENTION

The present disclosure relates generally to mounting assemblies. More specifically, the present disclosure describes mounting assemblies for demountable attachment to trees.

### BACKGROUND OF THE INVENTION

There is a need to provide outdoor lighting to residential and commercial properties. Such lighting facilitates outdoor activates at night. Outdoor lighting is also used to highlight the architectural features of buildings and to illuminate plants and trees. Crime deterrence is another benefit of outdoor lighting.

Trees often serve as the support for the outdoor lighting fixtures due to their height and sturdy structure, which can eliminate the need to use posts for the lighting fixtures. One common approach people attach lighting fixtures to trees is to use a plurality of fasteners to mount a bracket to the tree in order to support the lighting fixtures. Another approach is to apply a belt or cable around the tree trunk or a branch with a bracket and secure the lighting fixture to the bracket.

However, trees usually grow around such cables and belts as well as grow into the brackets, which can require that people adjust these devices periodically. Adjustment time can be consuming, inconvenient and dangerous (e.g., if the device is mounted high in a tree). Even more, these devices can cause damage or even result in the death of the tree if adjustments are not made to the devices in a timely manner. Moreover, the growing trees can also result in damaging the mounting brackets or even the attached lighting fixtures. There is a need in the art to address one or more of the aforementioned issues.

### BRIEF DESCRIPTION OF THE DRAWINGS

Some of the embodiments will be described in detail, with reference to the following figures, wherein like designations denote like members, wherein:

FIG. 1 depicts a mounting assembly, according to some embodiments.

FIG. 2 depicts a front view of a mounting base, according to other embodiments.

FIG. 3 depicts a perspective view of the mounting base, according to certain embodiments.

FIG. 4 depicts a front view of a fixture, according to yet still other embodiments.

FIG. 5 depicts a perspective view of a fixture, according to some embodiments.

FIG. 6 depicts a front view of a fixture affixed to a tree via the mounting assembly, according to other embodiments.

FIG. 7 depicts a side view of the affix to the tree of FIG. 6, according to certain embodiments.

FIG. 8 depicts a front view of fixtures affixed to a tree via the mounting assembly, according to yet still other embodiments.

FIG. 9 depicts a front view of a fixture affixed to a tree via the mounting assembly, according to some embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The present disclosure includes many aspects and features. Moreover, while many aspects and features relate to, and are described in the context of mounting assemblies for demountable attachment to trees, embodiments of the present disclosure are not limited to use only in this context. The instant disclosure seeks to provide mounting assemblies that secure objects to trees. The instant disclosure seeks to provide mounting assemblies that positionally adjust as the tree grows without the need for user assistance.

There is a need to provide outdoor lighting to residential and commercial properties. Such lighting facilitates outdoor activates at night. Outdoor lighting is also used to highlight the architectural features of buildings and to illuminate plants and trees. Crime deterrence is another benefit of outdoor lighting.

Trees often serve as the support for the outdoor lighting fixtures due to their height and sturdy structure, which can eliminate the need to use posts for the lighting fixtures. One common approach people attach lighting fixtures to trees is to use a plurality of fasteners to mount a bracket to the tree in order to support the lighting fixtures. Another approach is to apply a belt or cable around the tree trunk or a branch with a bracket and secure the lighting fixture to the bracket.

However, trees usually grow around such cables and belts as well as grow into the brackets, which can require that people adjust these devices periodically. Adjustment time can be consuming, inconvenient and dangerous (e.g., if the device is mounted high in a tree). Even more, these devices can cause damage or even result in the death of the tree if adjustments are not made to the devices in a timely manner. Moreover, the growing trees can also result in damaging the mounting brackets or even the attached lighting fixtures. There is a need in the art to address one or more of the aforementioned issues.

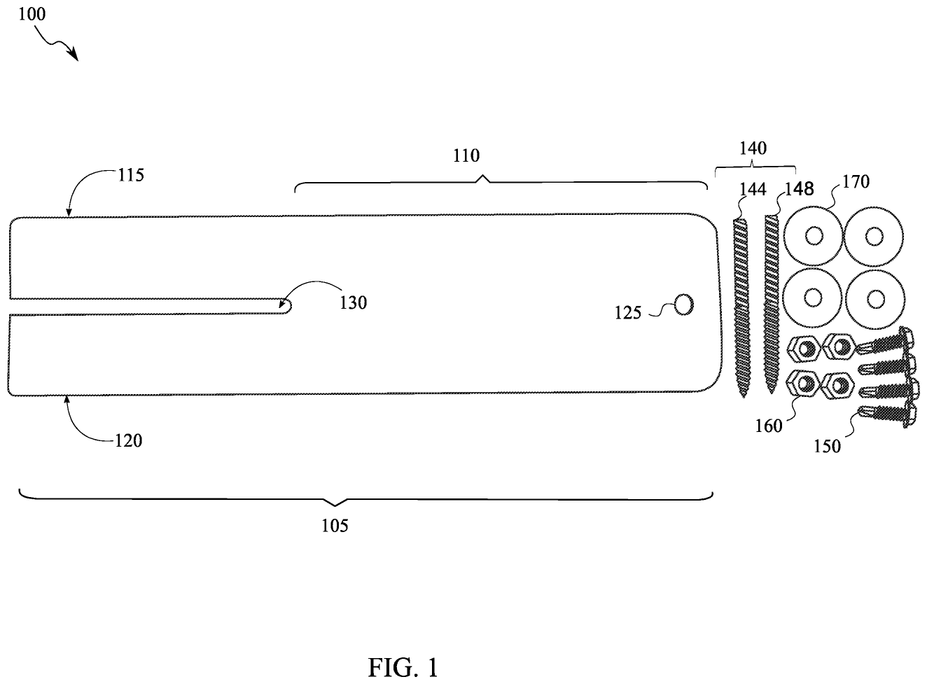

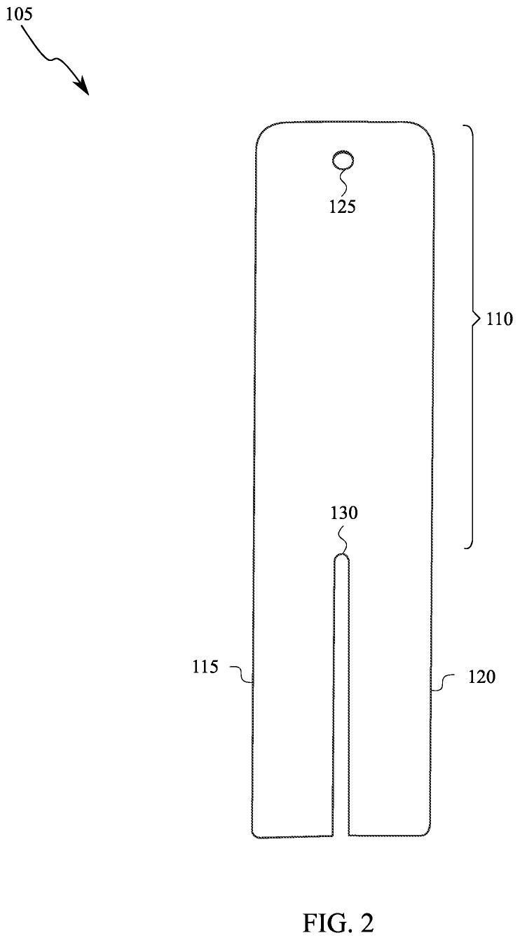

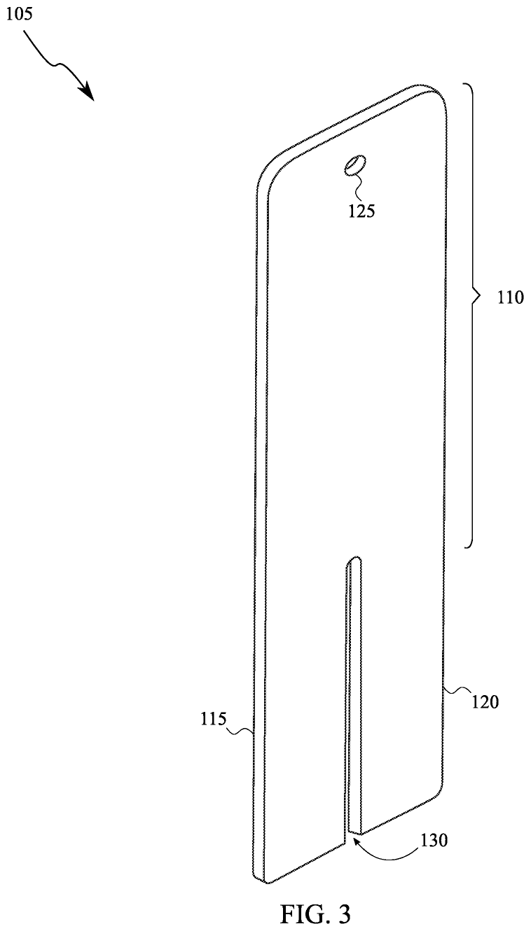

FIGS. 1-7 are included herein to facilitate the discussion of the instant disclosure. FIG. 1 depicts a front view of a mounting assembly, generally 100, for demountable attachment to a tree, according to some embodiments. The mounting assembly 100 affixes a variety of fixtures to trees and has a many features not currently known in the art. For example, the mounting assembly 100 positionally adjusts as the tree grows without the need for user assistance. As used herein, “fixtures” refers to equipment or furniture that can be fixed in position to trees using the mounting assembly.

For example, applicable fixtures include, but are not limited to, lighting fixtures, electrical boxes, brackets, housings, signage, and similar objects. Although the mounting assembly 100 can be made of any material that has mechanical properties that support being stored outdoors for extended periods of time (e.g., various metals, polymers, alloys, and combinations thereof), the mounting assembly is preferably made of aluminum. It should be noted that the mounting assembly 100 as well as its components can each be of any shape, size, and include any material, features, type or kind, orientation, components, and arrangements of components that would facilitate one or more of the objectives and intents of the instant disclosure.

The mounting assembly 100 preferably includes a mounting base 105, a plurality of primary fasteners 140, and a plurality of secondary fasteners 150. The mounting base 100 includes a main body 110, a first arm 115, and a second arm 120. The main body 110 includes a mounting hole 125 that is medially located on the main body 110. The mounting base 105 is adapted to be attached to a tree via the plurality of primary fasteners 140. The mounting base 105 is preferably planar and rectangular. The first arm 115 and the second arm 120 each extend from the main body 110 opposite the mounting hole 125 and thereby form a mounting slot 130. The first arm 115 and the second arm 120 are each preferably planar and rectangular. The mounting slot 130 is positioned along the length of both the first arm 115 and the second arm 120. In other words, the mounting slot 130 is preferably the same length of the first arm 115 and the second arm 120.

The mounting slot 130 is longitudinally positioned along the mounting base 105. The mounting slot 130 is preferably medially positioned on the mounting base 105. The mounting slot 130 is positioned adjacent to and between the first arm 115 and the second arm 120. Each primary fastener 140 is preferably a double ended thread bolt adapted to be screwed in to the tree at one end and to receive a nut at the other. In other words, each primary fastener 140 is a headless bolt that is threaded at both ends such that one end is adapted to be screwed in to a tree and the other end is adapted to receive a threaded nut (e.g., a nut 160). The plurality of primary fasteners 140 include a first fastener 144 and a second fastener 148. The first fastener 144 is demountably positioned in the mounting hole 125. The second fastener 148 is slidably and demountably positioned in the mounting slot 130, which allows the second fastener 148 to longitudinally slide along the mounting slot 130 as the tree lengthen and grows.

Although there are many configurations in which the mounting base 105 can be affixed to the primary fasteners 140, the mounting base 105 is preferably selectively positioned between a pair of the nuts 160 when affixed to the first fastener 144. Similar, the mounting base 105 is preferably positioned between a pair of the washers 170 which are themselves positioned between a pair of the nuts 160, which thereby facilitates the traversal of the second faster 148 along the mounting slot 130. In this manner, users manipulate the nuts 160 to move the mounting base 105 to any position along the primary fasteners 140 and thereby adjust the distance of the mounting base 105 from the tree (e.g., as the tree grows). In other embodiments, the mounting base 105 is coupled to the primary fasteners 140 via one of the nuts 160.

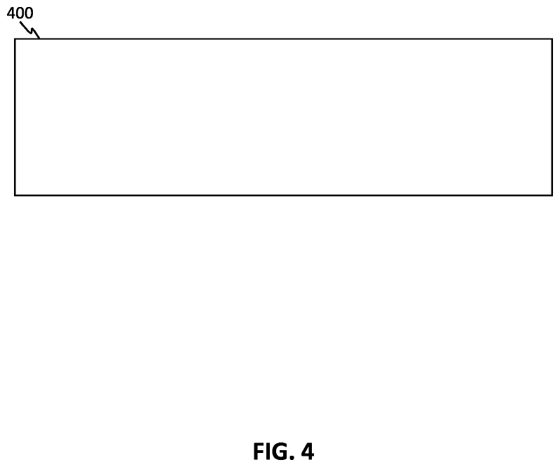

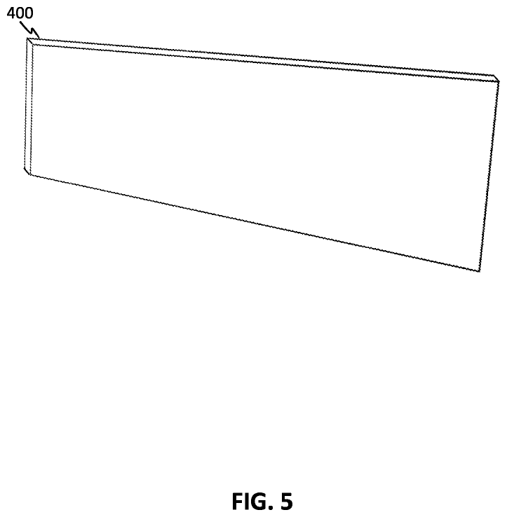

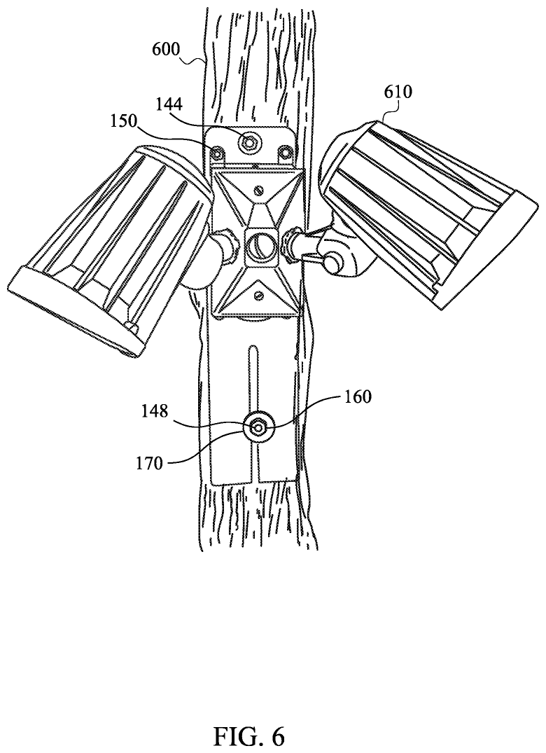

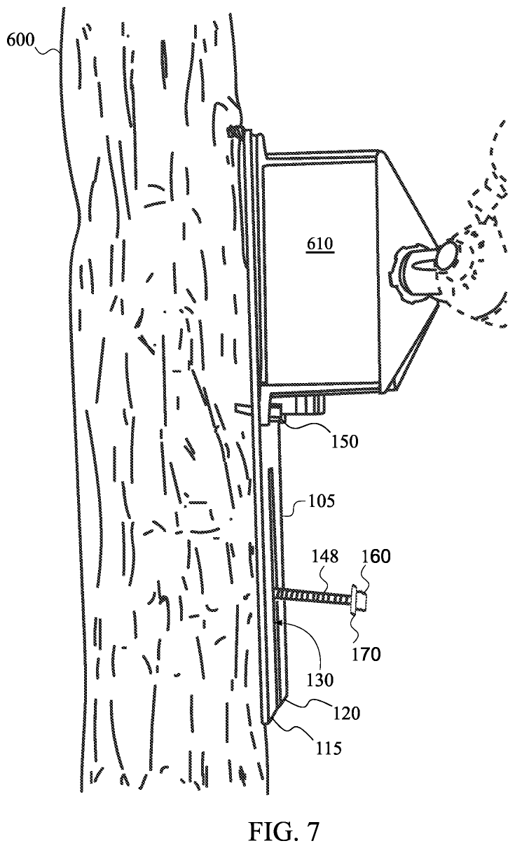

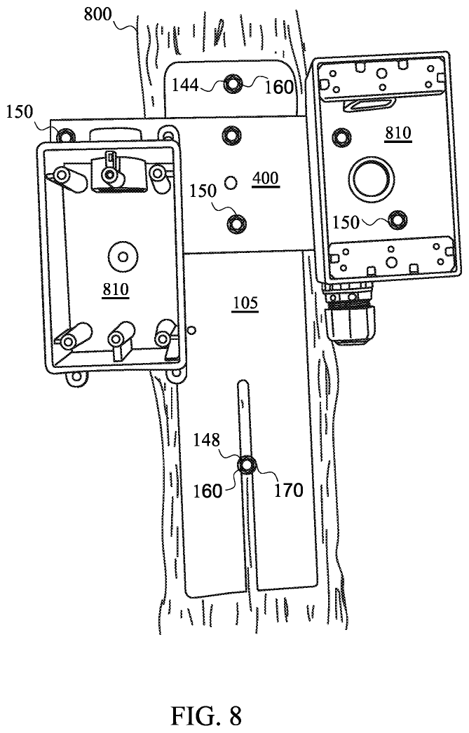

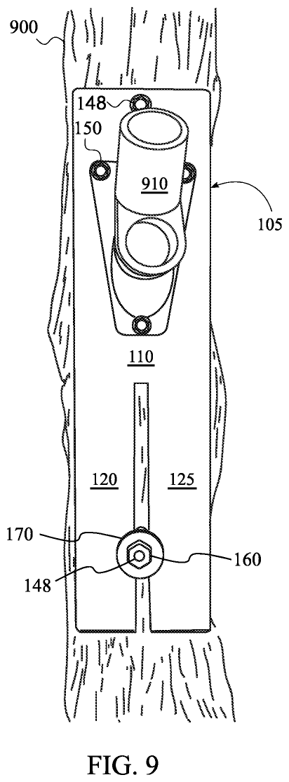

The secondary fasteners 150 are adapted to affix a fixture (discussed below) to the main body 110. Each secondary fastener 150 is a self-drilling screw that can be driven in to the main body 110. In preferred embodiments, the main body 110 does not contain pre-drilled holes, which allows the secondary fasteners 150 to affix the fixtures at any user-defined position on the main body 110. For example, applicable fixtures include, but are not limited to, a fixture 400 which is a plate (FIGS. 4-5) that additional fixtures can be affixed to (e.g., the fixture 610, the fixture 810, the fixture 910, similar fixtures, or a combination of two or more thereof), a fixture 610 which is a lighting assembly (FIGS. 6-7), a fixture 910 which is a bracket (FIG. 9), a fixture 810 which is a housing (FIG. 8), or a combination of two or more thereof. The fixture 400 is preferably rectangular and planar. For example, FIGS. 6-7 depict the fixture 610 (a lighting assembly) affixed to a tree 600 via the mounting assembly 100. FIG. 8 depicts the fixture 810 (a plate) and the fixture 400 (housings) affixed to a tree 800 via the mounting assembly 100. Here, the fixture 400 is affixed to the fixture 810. FIG. 9 depicts the fixture 910 (a bracket) affixed to a tree 900 via the mounting assembly 100.

Although the disclosure has been explained in relation to its preferred embodiment, it is to be understood that many other possible modifications and variations can be made without departing from the spirit and scope of the disclosure.

What is claimed is:

1. A mounting assembly for demountable attachment to a tree, comprising:
a mounting base;
a plurality of primary fasteners;
a plurality of secondary fasteners;
wherein
the mounting base comprises:
a main body;
a first arm;
a second arm;
the main body comprises a mounting hole that is medially located on the main body;
the first arm and the second arm each extend from the main body opposite the mounting hole and thereby form a mounting slot;
the mounting slot is longitudinally positioned along the mounting base;
the plurality of primary fasteners comprise a first fastener and a second fastener, the first fastener demountably positioned in the mounting hole, the second fastener slidably and demountably positioned in the mounting slot
the mounting base is adapted to be attached to the tree via the plurality of primary fasteners; and
the secondary fasteners are adapted to affix a fixture to the main body.

2. The mounting assembly of claim 1, wherein the mounting base is planar and rectangular.

3. The mounting assembly of claim 2, wherein
the first arm and the second arm are
positioned proximate to each other; and
oriented parallel to each other.

4. The mounting assembly of claim 3, wherein
the mounting slot is positioned adjacent to and between the first arm and the second arm.

5. The mounting assembly of claim 4, wherein
the mounting slot is medially positioned on the mounting base.

6. The mounting assembly of claim 5, wherein
each primary fastener is a double ended thread bolt that is adapted to be screwed in to the tree and to receive a nut.

7. The mounting assembly of claim 6, wherein
each secondary fastener is a self-drilling screw.

8. The mounting assembly of claim 7, wherein
the fixture comprises a plate; and
the plate is rectangular and planar.

9. The mounting assembly of claim 7, wherein
the fixture comprises a lighting assembly.

10. The mounting assembly of claim 7, wherein the fixture comprises a bracket or a housing.

11. A mounting assembly for demountable attachment to a tree, comprising:
a mounting base;
a plurality of primary fasteners;
a plurality of secondary fasteners;
wherein
the mounting base comprises:
a main body;
a first arm;
a second arm;
the mounting base is planar and rectangular;
the main body comprises a mounting hole that is medially located on the main body;
the first arm and the second arm each extend from the main body opposite the mounting hole and thereby form a mounting slot;
the mounting slot is longitudinally positioned along the mounting base;
the plurality of primary fasteners comprise a first fastener and a second fastener, the first fastener demountably positioned in the mounting hole, the second fastener slidably and demountably positioned in the mounting slot
the mounting base is adapted to be attached to the tree via the plurality of primary fasteners; and
the secondary fasteners are adapted to affix a fixture to the main body.

12. The mounting assembly of claim 11, wherein
the first arm and the second arm are
positioned proximate to each other; and
oriented parallel to each other.

13. The mounting assembly of claim 11, wherein
the mounting slot is positioned adjacent to and between the first arm and the second arm.

14. The mounting assembly of claim 11, wherein
the mounting slot is medially positioned on the mounting base.

15. The mounting assembly of claim 11, wherein
each primary fastener is a double ended thread bolt that is adapted to be screwed in to the tree and to receive a nut.

16. The mounting assembly of claim 11, wherein
each secondary fastener is a self-drilling screw.

17. The mounting assembly of claim 11, wherein
the fixture comprises a plate; and
the plate is rectangular and planar.

18. The mounting assembly of claim 11, wherein
the fixture comprises a lighting assembly.

19. The mounting assembly of claim 11, wherein
the fixture comprises a bracket or a housing.

20. A mounting assembly for demountable attachment to a tree, comprising:
a mounting base;
a plurality of primary fasteners;
a plurality of secondary fasteners;
wherein
the mounting base comprises:
a main body;
a first arm;
a second arm;
the mounting base is planar and rectangular;
the main body comprises a mounting hole that is medially located on the main body;
the first arm and the second arm each extend from the main body opposite the mounting hole and thereby form a mounting slot;
the mounting slot
is longitudinally positioned along the mounting base;
is positioned adjacent to and between the first arm and the second arm;
is medially positioned on the mounting base;
the plurality of primary fasteners comprise a first fastener and a second fastener, the first fastener demountably positioned in the mounting hole, the second fastener slidably and demountably positioned in the mounting slot
the mounting base is adapted to be attached to the tree via the plurality of primary fasteners;
each primary fastener is a double ended thread bolt that is adapted to be screwed in to the tree and to receive a nut;
the secondary fasteners are adapted to affix a fixture to the main body;
the fixture comprises at least one of a plate;
a lighting assembly;
a bracket; and
a housing.
